(19) United States
(12) Patent Application Publication
(10) Pub. No.: US 2022/0099839 A1
(43) Pub. Date: Mar. 31, 2022

(54) SYSTEMS AND METHODS FOR LIGHT BACKSCATTERING MITIGATION IN LIDAR SYSTEMS

(71) Applicant: ARGO Al, LLC, Pittsburgh, PA (US)

(72) Inventor: Michael V. MORELLI, San Jose, CA (US)

(73) Assignee: ARGO Al, LLC, Pittsburgh, PA (US)

(21) Appl. No.: 17/600,011

(22) PCT Filed: Jan. 15, 2021
(86) PCT No.: PCT/US2021/013704

§ 371 Date: Sep. 29, 2021

Related U.S. Application Data
(60) Provisional application No. 62/965,765, filed on Jan. 24, 2020.

(51) Int. Cl. G01S 17/931; G02B 27/28; G02B 27/30; G02B 5/30; G01S 7/481

(52) U.S. Cl. CPC G01S 17/931; G02B 27/283; G01S 7/4816; G02B 5/3083; G02B 27/30

(57) ABSTRACT

Systems and methods are provided herein for light backscattering mitigation in LIDAR systems in some embodiments, an example method may include emitting, by an emitter, an outbound light signal. The example method may also include receiving, by a circulator disposed a first path of the outbound light signal and a second path of a return light signal, the outbound light signal from the emitter. The example method may also include outputting the outbound light signal. The example method may also include receiving, by the circulator, the return light signal from an environment, the return light signal comprising a first portion in a first polarization state and a second portion in a second polarization state. The example method may also include providing, by the circulator and on a third path, the first portion of the return light signal to a first element.

### CROSS-REFERENCE TO RELATED APPLICATIONS

This application claims priority benefit of U.S. Provisional Patent Application No. 62/965,765, filed Jan. 24, 2020, the disclosure of which is incorporated by reference herein.

### TECHNICAL FIELD

The present disclosure relates to Light Detection and Ranging (LIDAR) systems and more specifically, optical systems in LIDAR systems.

### BACKGROUND

LIDAR systems may often be used for detecting objects within an environment, and are becoming more prevalent in vehicles for use in semi-autonomous and autonomous functionality. Such LIDAR system may include one or more emitter devices and one or more receiver devices. The emitter devices may emit light signals at various frequencies and intensities, and in various directions outwards from the vehicle. These light signals may reflect from objects in the environment and return to the vehicle, at which point they may be received by the one or more receiver devices. However, upon emission from the emitter devices, some of the light signal may reflect back on the receiver devices, which may results in the discharging of the receiver devices, and consequentially, a temporary saturation and blind period of the receiver devices. Additionally, LIDAR systems may only be able to receive as little as half of the emitted light signal back at the receiver devices due to loss of polarization states.

### BRIEF DESCRIPTION OF THE DRAWINGS

The detailed description is set forth with reference to the accompanying drawings. The use of the same reference numerals may indicate similar or identical items. Various embodiments may utilize elements and/or components other than those illustrated in the drawings, and some elements and/or components may not be present in various embodiments. Elements and/or components in the figures are not necessarily drawn to scale. Throughout this disclosure, depending on the context, singular and plural terminology may be used interchangeably.

FIG. 1 depicts a schematic of an illustrative LIDAR vehicle system, in accordance with one or more example embodiments of the disclosure.

FIG. 2 depicts an example prior optical system, in accordance with one or more example embodiments of the disclosure.

FIG. 3 depicts an example modified optical system, in accordance with one or more example embodiments of the disclosure.

FIG. 4 depicts an example method, in accordance with one or more example embodiments of the disclosure.

FIG. 5 depicts an example computing system, in accordance with one or more example embodiments of the disclosure.

### DETAILED DESCRIPTION

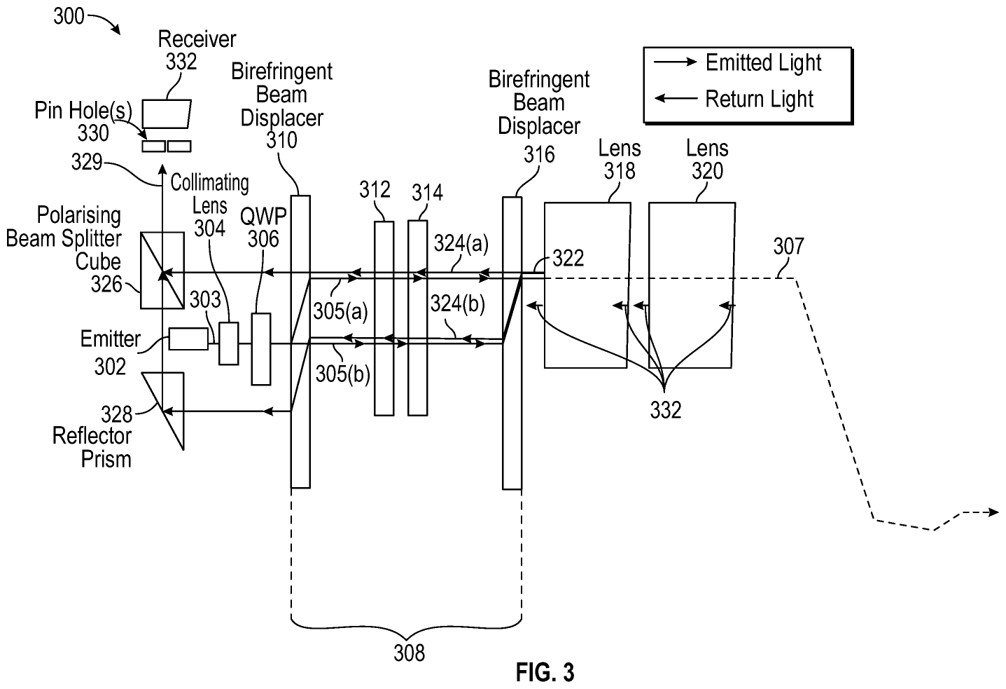

This disclosure relates to, among other things, systems and methods for backscatter mitigation or removal in LIDAR systems. Backscatter may refer to a scenario where some of the light emitted by an emitter of a LIDAR system is reflected by internal components within the LIDAR system. This internally-reflected light may then be prematurely directed back towards one or more receivers within the LIDAR system. A receiver may be intended to be used to capture return light from objects in an environment external to the LIDAR system (for example, trees, pedestrians, or vehicles, among various other types of objects that may exist). Based on factors associated with the return light (for example, the amount of time between a time at which the light was emitted and a time at which return light is detected), the LIDAR system may be able to provide information about the objects in the environment. This may be useful for a number of purposes, such as assisting an autonomous vehicle in identifying what objects exist around it in the environment (this also may be useful in a number of other contexts outside the realm of autonomous vehicles as well). However, some types of receivers (as may be described below) may enter a recovery period after receiving return light. During this recovery period, a receiver may be incapable of detecting any additional return light. Thus, the receiver may be “blind” to any return light. Given this, it may be problematic if a receiver is caused to enter its recovery period based on internally-reflected light because this may result in the receiver being in its recovery period when the remaining light is ultimately output from the LIDAR system. The receiver being within its recovery period during this time may cause the receiver to be incapable of detecting any return light reflecting from objects within a short distance of the LIDAR system (return light that may reach the receiver after only a short period of time). Additionally, the systems and methods disclosed herein may also address scenarios where a portion of a return signal is lost due to the return signal including multiple polarization states. Light in different polarization states may interact with elements within the LIDAR system in different ways, so if the LIDAR system does not include proper hardware configurations (for example, as described herein), it is possible that some or all of the return light signal may not be received by the receivers. This may also be problematic because the LIDAR system may be receiving only partial information about the objects in the environment. These two particular concerns may be addressed through the use of a circulator in the LIDAR optics system in place of a polarizing beam splitter (PBS), which may be described in further detail below (for example, with respect to FIG. 3).

In some embodiments, a polarizing beam splitter may be an optical element that is configured to reflect light in one particular polarization state and transmit light in another polarization state (or at least a certain percentage of light in a particular polarization state, for example, the polarizing beam splitter may be configured to reflect 95% of p polarized light and transmit 5% of p polarized light). Reflecting light may refer to the PBS changing the direction of travel of the light, whereas transmitting light may refer to the PBS allowing light to continue through the PBS in the same direction it entered the PBS. As an example, the polarizing beam splitter may be configured to reflect p polarized light and may be configured to transmit s polarized light. Additionally, while the above example describes a polarizing beam splitter that may primarily reflect p polarized light, in some instances, the polarizing beam splitter may also be configured to primarily reflect s polarized light as well. That is, the manner in which light is impacted by the PBS may not necessarily be limited to the above example, but may rather depend on the configuration of the particular PBS (for example, another PBS may transmit 85% of p polarized light and may reflect 15% of s polarized light). Depending on the LIDAR system configuration (for example, the position of the receiver relative to the PBS), either the light that is reflected or the light that is transmitted may not be detected by the receiver, and may consequentially be “lost.” For example, if the receiver is positioned relative to the PBS such that light traveling through the PBS would be detected by the receiver, then any light of a polarization state that is reflected by the PBS would be reflected away from the receiver, and consequentially and not detected by the receiver.

In contrast, the systems described herein may use a circulator in place of the PBS. In some cases, the circulator may be an optical circulator comprised of a fiber-optic component that can be used to separate upstream signals and downstream signals. The optical circulator may be a three-port or four-port device (or any other number of ports) in which an optical data signal entering one port may exit the next port. The optical circulator may be in the shape of a square, with a first port on the left side of the square, a second port on the right side of the square, and a third port on the bottom side of the square. A first optical data signal (e.g., a downstream signal) entering the first port may exit the second port. A second optical data signal (e.g., an upstream signal) entering the third port may exit the first port. In some instances, the circulator may also be round baud. The circulator may a single stage circulator, or may be a dual stage circulator. The circulator may also be any other shape with any number of stages or number of ports as well. The use of a circulator may reduce or remove light backscatter by separating one or more optical paths (for example, optical paths of outbound and return signs, as well as any other optical paths) and may also allow for as much of an emitted light signal as possible to return to the receiver devices by capturing multiple returning polarization states (instead of transmitting one, or part of one, polarization state and reflecting one, or part of one, polarization state, as would happen in an optical system using the PBS). Thus, the use of the circulator in the LIDAR optics system may serve as an improvement to prior LIDAR optics systems.

More particularly, the circulator may be used to mitigate the backscatter concerns described above by allowing for the spatial separation of the paths being taken by light in the LIDAR system. For example, the circulator may allow for any paths taken by the outbound light (for example, light emitted by an emitter) to be spatially separated from any paths taken by the return light. With this spatial separation, any backscatter based on the outbound path(s) may occur outside of the return light path(s). Thus, the backscatter light may not reach any of the receiver(s), and thus may not cause any of the receiver(s) to prematurely enter a recovery period. The use of the circulator may also mitigate the potential loss of portions of a return light signal in different polarization states by directing the portions of the light in different polarization states to different elements within the LIDAR system that may cause the portions of the light in the different polarization states to be directed towards the receiver(s). This may be described in more detail with respect to FIG. 3.

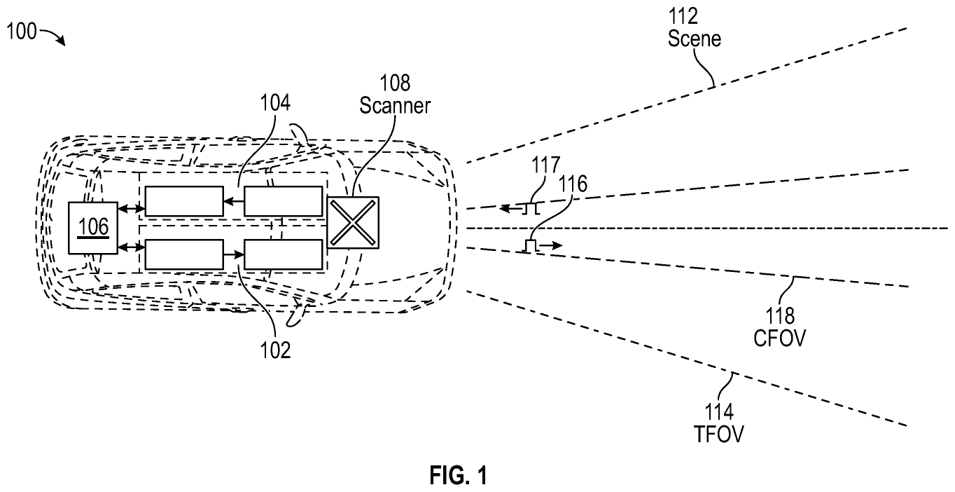

Turning now to the drawings, FIG. 1 is a schematic drawing of an illustrative LIDAR system 100 according to an aspect of the present disclosure. The LIDAR system 100 may be an example of a LIDAR system that may include the optical elements described herein. As shown in that FIG. 1, the LIDAR system 100 may include one or more transmitter(s) 102, one or more receiver(s) 104, one or more computing system(s) 106, and one or more scanner(s) 108, which may be shown as being arranged and mounted on an automobile (vehicle). However, the LIDAR system 100 may also be implemented on systems other than vehicles as well.

As will be readily understood by those skilled in the art, system 100 may be suitably configured and operative to interrogate a scene 112 within an overall detection region with a series of optical pulses 116 and detecting reflections of those pulses 117. From those reflections received/detected from the scene 112, the system 100 may determine the location of any objects within the scene from arrival time(s) of the reflection(s). Note that as used herein, a scene such as scene 112 may simply be a place or location where the LIDAR interrogation takes place.

As may be further observed from FIG. 1, scene 112 may be defined by a total field of view (TFOV) 214 which has a lateral extent along an x-direction and a vertical extent along a y-direction.

In some embodiments, emitter 102 may be a system for generating and/or transmitting optical signals (not specifically shown) that generally may include a train of relatively short-duration optical (laser) pulses. As may be appreciated, such optical signals may include a first divergence in the y-direction (i.e., vertical) and a second divergence in the x-direction (i.e., horizontal). The emitter 102 may also be referred to as an “emitter,” “emitter device,” “laser,” or the like herein.

In some embodiments, receiver 104 may include a focal-plane array comprising, for example, an array of pixels, each of which may include a single-photon receiver and optics that define the instantaneous field-of-view of the pixel. In the illustrative embodiment shown in FIG. 1, the optics of each pixel may provide an instantaneous field-of-view (IFOV) of approximately 0.2 degrees in the x-direction and approximately 1.4 degrees in the y direction (as well as any other degree values in either direction). The optics of the pixels may advantageously be collectively dimensioned and arranged to compress the IFOVs of the pixels along the x-direction such that they may collectively form a composite field-of-view 118 such that it may exhibit substantially no gaps between the IFOVs of the individual pixels. In other words, it may exhibit a continuous field-of-view in each dimension. The receiver 104 may be referred to as “receivers,” “photodetectors,” “photodiodes,” or the like herein. Additionally, reference may be made herein to a single “photodetector” or “photodiode,” but the LIDAR systems described herein may also similarly include any number of such receivers). In some instances, the receivers may be photodiodes, which may be diodes that are capable of converting incoming light photons into an electrical signal (for example, an electrical current). The receivers may be implemented in a LIDAR system that may emit light into an environment and may subsequently detect any light returning to the LIDAR system (for example, through the emitted light reflecting from an object in the environment) using the receivers. As one example implementation, the LIDAR system may be implemented in a vehicle (for example, autonomous vehicle, semi-autonomous vehicle, or any other type of vehicle), however the LIDAR system may be implemented in other contexts as well. The receivers may also more specifically be Avalanche Photodiodes (APD), which may function in the same manner as a normal photodiode, but may operate with an internal gain as well. Consequentially, an APD that receives the same number of incoming photons as a normal photodiode will produce a much greater resulting electrical signal through an “avalanching” of electrons, which allows the APD to be more sensitive to smaller numbers of incoming photons than a normal photodiode. An APD may also operate in Geiger Mode, which may significantly increase the internal gain of the APD.

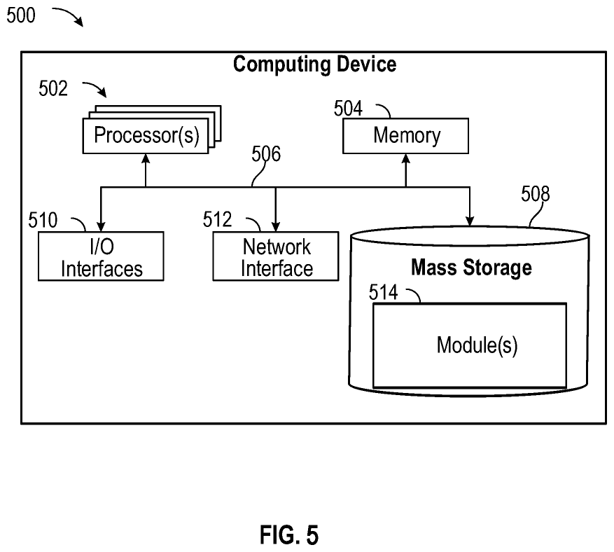

With continued reference to FIG. 1, the computing system 106 may include any of a variety of known, integrated or discrete systems that among other things receive signals from receiver 104, determine object locations based on signals, generating a point cloud for a scene 112, controlling the scanner 108, and the like. The computing system 106 may be described below in more detail with respect to FIG. 5.

In some embodiments, the scanner 108 may be operative to scan optical signal(s) and CFOV 118 across scene 112 during a scan period such that overall system 100 may interrogate and sample the entirety of scene 112 during each such scan period. As may be readily appreciated, the particular choice of scanner may be a matter of design choice. Accordingly, scanner 108 may include a galvanometer scanner, a rotating, multi-faceted mirror, a scanning MEMS mirror, and/or a transmissive element(s) (i.e., a scanning prism, etc.) that steers optical signals via any of a number of known mechanisms including refraction, and the like. Those skilled in the art will of course recognize that a scanner 108 according to the present disclosure may further include a mix of the scanning elements described and/or known.

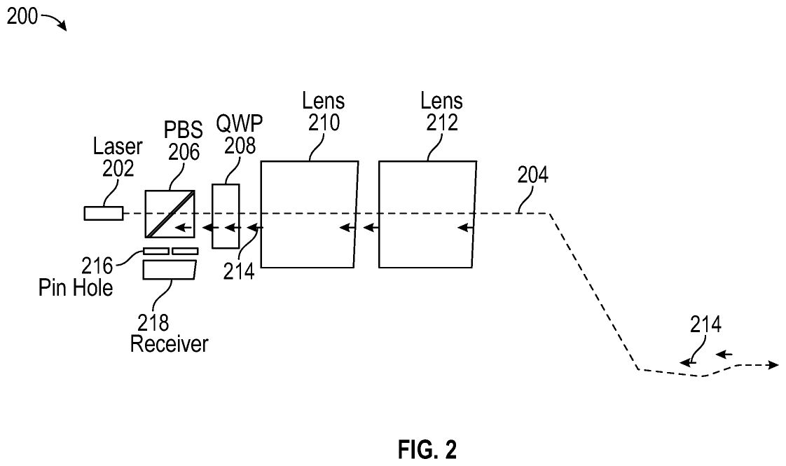

FIG. 2 depicts an example prior optical system 200. In some embodiments, the optical system 200 may represent the optics included in association with emitter device(s) and receiver device(s) (a LIDAR system described herein may include and number of receiver device(s) and/or emitter device(s)) of the LIDAR system (for example, emitter 102 and/or receiver 104 described with respect to FIG. 1). The optical system 200 may represent an optical system that may not include the additions described herein (for example, additions described with respect to FIG. 3 below). The prior optical system 200 may include an emitter 202, a polarizing beam splitter (PBS) 206, a quarter wave plate (QWP) 208, a first lens 210, a second lens 212 (or any other number of lenses), a pin hole 216, and a photodetector 218 (for example, a Silicon photomultiplier (SiPM), avalanche photodiode (APD), or any other type of photodetector described herein or otherwise). The optical system 200 may transmit an outbound light signal 204 from the emitter 202, which may pass through the PBS 206, through the QWP 208, through the first lens 210 and/or second lens 212 (or any other number of lenses), and into the environment. The return light signal 214 may pass through the second lens 212 and the first lens 210 (or any other number of lenses), back through the QWP 208, through the PBS 206, and through the pin hole 216 into the photodetector 218.

In some embodiments, the PBS 206 may split a light signal into two polarization states and may allow one polarization state to pass through, while reflecting the other polarization state. On the emission side (for example, light being emitter from the emitter 202), this may result in photons being reflected towards the photodetector 218 (for example, backscattering of photons). As aforementioned, this backscattering may cause the photodetector 218 to become overburdened with photons, resulting in a saturation of the photodetector 218, which may result in a period of time during which it is blind to photons returning from being reflected from objects in the environment. On the receiving side (for example, light returning after being reflected from an object in the environment), the PBS 206 may result in one of the polarization states being lost prior to detection by the photodetector 218. For example, the PBS 206 may be configured to reflect 95% of p polarized light and transmit 5% of p polarized light). Reflecting light may refer to the PBS 206 changing the direction of travel of the light, whereas transmitting light may refer to the PBS 206 allowing light to continue through the PBS 206 in the same direction it entered the PBS 206. As an example, the polarizing beam splitter may be configured to reflect p polarized light and may be configured to transmit s polarized light. Additionally, while the above example describes a polarizing beam splitter that may primarily reflect p polarized light, in some instances, the polarizing beam splitter may also be configured to primarily reflect s polarized light as well. That is, the manner in which light is impacted by the PBS 206 may not necessarily be limited to the above example, but may rather depend on the configuration of the particular PBS 206 (for example, another PBS 206 may transmit 85% of p polarized light and may reflect 15% of s polarized light). Depending on the LIDAR system configuration (for example, the position of the receiver relative to the PBS 206), either the light that is reflected or the light that is transmitted may not be detected by the receiver, and may consequentially be “lost.” For example, if the receiver is positioned relative to the PBS 206 such that light traveling through the PBS 206 would be detected by the receiver, then any light of a polarization state that is reflected by the PBS 206 would be reflected away from the receiver, and consequentially and not detected by the receiver.

FIG. 3 depicts an example modified optical system 300. In some embodiments, the optical system 300 may improve upon the optical system 200 in that it may mitigate or remove issues that may arise from backscatter of light emitted from the emitter 302. The optical system 300 may also improve upon optical system 200 in that it may preserve multiple polarization states of a light signal so that the receiver 332 may receive an optimal number of photons from an emitted signal by the emitter 302 (for example if both polarization states of the return light signal are captured, up to as many as twice the number of photons may be received than if a polarization state is lost). Finally, the optical system 300 may also improve upon optical system 200 by increasing an extinction ratio between emitted light signals and return light signals. These improvements may be accomplished, at least in part, by replacing the PBS 206 of optical system 200 with a circulator 308 as shown in FIG. 3. The circulator 308, for example, may be a three port circulator, with one port for the emitter 302, one port for the receiver 332, and one port for an output. However, the circulator may also be any other type of circulator with any number of ports. The circulator 308 may include a first birefringent beam displacer 310, a faraday rotator 312, a half-wave plate 314, and a second birefringent beam displacer 316, as well as any other combination of different numbers and/or types of elements.

In some embodiments, the optical system 300 may also include other elements that may not be included in the optical system 200. For example, optical system 300 may also include a polarizing beam splitter cube 326, a reflector prism 328, and a collimating lens 304. Additionally, the optical system 300 may also share some elements with the optical system 200. For example, the optical system 300 may include an emitter 302, a quarter wave plate (QWP) 306, a first lens 318, a second lens 320 (or any other number of lenses), a pin hole 330, and a receiver 332. The optical system 300 may also transmit an outbound light signal 303 from the emitter 302 and may receive a return light signal 329 at the receiver 332. The optical system 300 may also include any other combination of different types of elements either depicted in or not depicted in the figure. Additionally, any of the elements depicted in the figure may be rearranged to be included in any other order as well.

In some embodiments, transmission of a light signal through the optical system 300 may be performed as follows. First, a light signal 303 may be generated and emitted by the emitter 302. The light emitted by the emitter 302 may be unpolarized light or may be light in one or more different polarization states. The light signal 303 may then pass through a collimating lens 304. The collimating lens 304 may narrow the light signal 303 output from the emitter 302. After being output by the collimating lens 304, the light signal 303 may pass through a QWP 306. The QWP 306 may be agnostic of the emitter 302 polarization and may convert the light signal 303 from a linear polarization to a circular or elliptical polarization. From the QWP 306, the light signal 303 may enter the circulator 308, beginning with the first birefringent beam displacer 310. The first birefringent beam displacer 310 may separate the light signal 303 into two (or any other number) portions in two polarization states (for example, light signal in a first polarization state on a first path 305(a) and light signal in a second polarization state on a second path 305(b)). The two polarization states may be separated along two different transmission paths, which may be orthogonal to one another in some cases. The two polarization states may be any type of polarization state, such as p polarized light, s polarized light, or any other type of polarization state, to name a few non-limiting examples. In other embodiments, the birefringent beam displacer may simply transmit the light signal 303 without splitting it into separate polarization states. Additionally, in some instances, the output of the first birefringent beam displacer 310 may depend on the polarization state of the light signal 303 entering the first birefringent beam displacer 310, among various other factors. For example, the polarization state of the light signal 303 may influence the polarization states of the light output by the first birefringent beam displacer 310, the paths taken by the light output by the first birefringent beam displacer 310, among other factors pertaining to the output of the first birefringent beam displacer 310. In some cases, the light signal 303 itself may be polarized, and in other instances the light signal 303 may be unpolarized. This may also play a role in the output of the first birefringent beam displacer 310.

After the light signal 303 is split into the two polarizations states by the first birefringent beam displacer 310, the light in the two polarization states may travel through the faraday rotator 312 and half-wave plate 314. The light signals in the two polarization states may then be re-combined at the second birefringent beam displacer 316 before being output from the circulator 308 as light signal 307. Finally, after being output from the circulator 308, the light signal 303 may pass through one or more lenses (for example, lens 318 and/or lens 320, or any number of other lenses) as light signal 307. It should be noted that although the light signal 303 is shown as traveling through all of the birefringent beam displacer 310, faraday rotator 312, half-wave plate 314, and second birefringent beam displacer 316 in the circulator 308, in some cases, the light signal 303 may also only travel through some of these elements depicted in the circulator 308. Additionally, the circulator 308 may only include some of the elements depicted in the figure as well.

Continuing with the progression of return light through the system 300, the output light signal 307 may reflect off an object (not shown in the figure) in the environment external to a LIDAR system including the optical system 300, and may return back to the optics system 300 as a return light signal 322. In some instances, the return light signal 322 may be in the form of two (or more) polarization states. The two polarization states may be the same or different than the polarization states of the emitted light signal 303. These polarization states of the return light signal 322 may both travel back through the optics system 300 and may enter the circulator 308, which may be disposed of in a path of an outbound signal (for example, light signal 303) emitted by the emitter 302, and also disposed of an a path of the return light signal 322 as well. In some instances, the circulator may spatially separate the portions of the return light signal in different polarization states into different return paths. For example, a first portion of the return light signal 322 in one polarization state may be provided onto a third path 324(a) and a second portion of the return light signal 322 in another polarization state may be provided onto a fourth path 324(b). However, in some cases, the portions of the return light in the different polarizations states may already be spatially separated, and the circulator may simply direct the different portions of the light in the different polarization states towards different elements used to direct the light towards the receiver 332. In some instances, the third path 324(a) and the fourth path 324(b) in the return direction may also be spatially separated from the first path 305(a) and second path 305(b) in the outbound direction. This may serve to assist in backscatter mitigation, as any photons that are internally reflected within the LIDAR system may be on a different path than the return paths that ultimately reach the receiver 332.

More specifically, the return light signal 322 may pass through one or more lenses (for example, lens 320, lens 318, and/or any other number of lenses) and be received by the second birefringent beam displacer 316. The second birefringent beam displacer 316 may then provide the portions of the return light signal 322 to different return paths through the circulator and ultimately to the receiver 332. For example, a first portion of the light signal in a first polarization state may pass through the one or more lenses (for example, lens 320, lens 318, and/or any other number of lenses) may be directed onto the third path 324(a). This first portion of the return light signal 322 may then traverse the third path 324(a) through the circulator 308, and through the polarizing beam splitter cube 326, which may reflect the first portion of the return light signal 322 in the first polarization state to the receiver 332. Similarly, a second portion of the light signal in a second polarization state may pass through the one or more lenses (for example, lens 320, lens 318, and/or any other number of lenses) may be directed onto the fourth path 324(b). This second portion of the return light signal 322 may then traverse the fourth path 324(b) through the circulator 308, and through the reflector prism 328, which may reflect the first portion of the return light signal towards the polarizing beam splitter cube 326. The polarizing beam splitter cube 326 may then transmit the second portion of the return light signal towards the receiver 332. This may allow the system 300 to capture both polarization states, as opposed to the optics system 200, which may lose one of the polarization states through the PBS 206. This may increase the total number of photons that return back to the receiver 332 from the emitted light signal 307 (for example, up to twice the photons may be received by the receiver 332 in the optics system 300 as opposed to optics system 200).

It should be noted that while the specific configuration presented in FIG. 3 is one configuration that may allow return light in multiple polarization states to be provided to a receiver 332, other configurations may also be applicable as well. These configurations may depend on several factors, such as the polarization states of the return light, the location of the receiver 332 within the LIDAR system, and/or the manner in which light in different polarization states interacts with various elements within the LIDAR system. For example, in one configuration, the polarizing beam splitter cube 326 may be configured to reflect p polarized light and transmit s polarized light. This configuration of polarizing beam splitter cube 326 may be used when the first portion of the return light is p polarized and the second portion of the light is s polarized. Additionally, continuing this same example, the reflector prism 328 may be configured to reflect s polarized light. Thus, this specific configuration may allow the p polarized return light to be reflected by the polarizing beam splitter cube 326 towards the receiver 332, and may allow the s polarized return light to be reflected by the reflector prism 328 towards the receiver 332, where the polarizing beam splitter cube 326 may also transmit the s polarized light from the reflector prism 328 to the receiver 332 (that is, the polarizing beam splitter 326 may allow the s polarized light to pass through it and continue towards the receiver 332). In this example, if all of the return light 332 were directed to the polarizing beam splitter cube 326, then the s polarized light may pass through the polarizing beam splitter cube 326 and never reach the receiver 332. Likewise, if all of the return light 332 were directed to the reflector prism 328, then the p polarized light may never reach the receiver 332. However, elements such as the polarizing beam splitter cube 326 and or the reflector prism 328 may have multiple configurations, with individual configurations causing different interactions with different polarization states. For example, the polarizing beam splitter cube 326 could also be configured to reflect s polarized light instead of transmit s polarized light. Thus, the configuration of the individual elements within the system 300 may be adjusted based on the polarization states of the return light.

Additionally, as mentioned above, the elements used to direct the return light (for example, the polarizing beam splitter and/or reflector prism in FIG. 3) may be any other number and or types of elements placed in any physical location in the system 300. That is, the system 300 may not necessarily need to include the polarizing beam splitter 326 and/or the reflector prism 328. For example, if the receiver 332 were located in a different physical location within the system 300, then the configuration of elements used to direct the return 332 light may be adjusted (or elements may be added and/or removed) to ensure that the different portions of the return light 332 in different polarization states are directed to any other location that the receiver may exist.

As aforementioned, in some embodiments, use of the circulator 308 in place of the PBS 206 may mitigate or remove light reflections back on the receiver 332 after emission by the emitter 302 (for example, backscattering of light). This may result because the PBS 206 may split a light signal emitted by the laser into polarization states, with one of the polarization states being reflected, whereas the circulator 308 may instead separate an emitted light signal into polarization states at the first birefringent beam displacer, may use the faraday rotor to separate the light onto two collinear paths, and then re-combine the polarization states at the second birefringent beam displacer. This may remove the reflection of portions of the emitted light signal back to the receiver 332 upon firing of the emitter 302. Additionally, the use of the circulator 308 may further serve to assist in preserving multiple polarization states for the receiver 332. That is, the circulator 308 may allow the receiver 332 to receive multiple return polarization states of an emitted light signal, resulting in more received photons and consequentially a boost in the received light signal. The circulator 308 may allow the receiver 332 to capture these additional polarization states because the circulator 308 may include multiple optical paths for the multiple polarization states. The multiple polarization states may pass through the circulator 308 and be combined at the polarizing beam splitter cube 326 before being received by the receiver 332. Finally, the circulator 308 may serve to increase the extinction ratio between the emitted light signal and the return light signal.

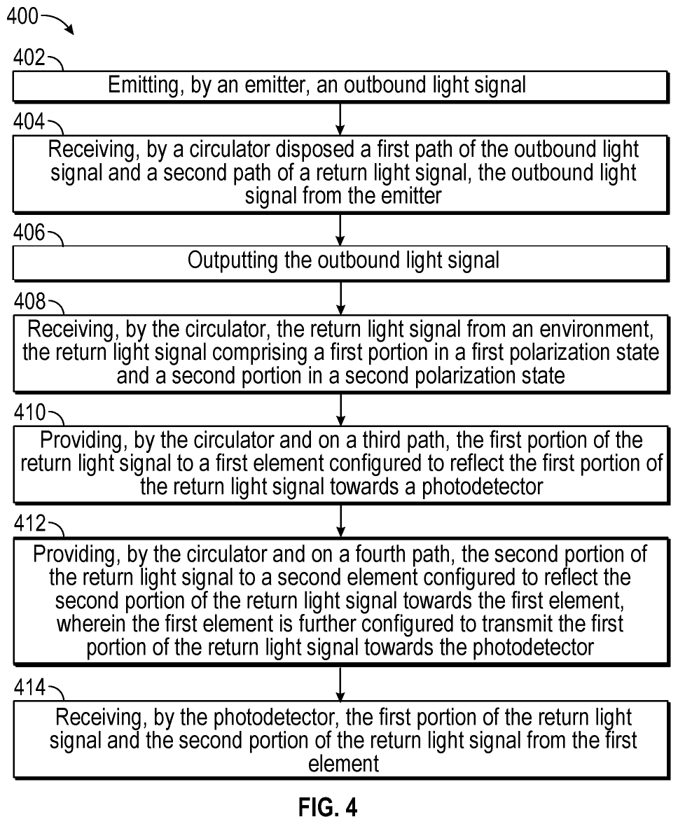

FIG. 4 is a flow of an example method 400 of the present disclosure. In some embodiments, the method includes a step 402 of emitting, by an emitter, an outbound light signal. The outbound light signal may be unpolarized light, may be light in a single polarization state, or may be light including multiple polarization states. The emitter may be the same as emitter 102, emitter 202, emitter 302, and/or any other emitter described herein. An “emitter” may also be referred to as a “transmitter,” “laser,” or the like herein as well. In some embodiments, the method 400 includes a step 404 of receiving, by a circulator disposed a first path of the outbound light signal and a second path of a return light signal, the outbound light signal from the emitter. In some embodiments, the method 400 includes a step 406 of outputting the outbound light signal. The circulator may be the same as circulator 308, as well as any other circulator described herein. The circulator may allow for emitted light and return light to be directed along particular paths (for example, the return light may be directed towards the location of the photodetector) regardless of the number of and/or types of polarization states that the emitted and/or return light may include. The circulator may also be used to spatially separate some or all of the different light paths. For example, the circulator may be used to separate the outbound light path(s) and the return light path(s). This may serve to mitigate any concerns with internal backscatter taking place and blinding a receiver in the LIDAR system when the outbound light is emitted by the emitter (for example, as described above). The circulator may also be used for other purposes as well, however.

In some embodiments, the circulator further comprises a first birefringent beam displacer, wherein providing the first portion of the return light signal to the first element and providing the second portion of the return light signal to the second element are performed by the first birefringent beam displacer, and wherein the method further comprises separating, by the first birefringent beam displacer, the outbound light signal into a first portion of the outbound light signal in a third polarization state and a second portion of the outbound light signal in a fourth polarization state. In some embodiments, wherein the circulator further comprises a second birefringent beam displacer, and wherein the method further comprises separating, by the second birefringent beam displacer, the first portion of the return light signal onto the first path and the second portion of the return light signal onto the second path. The circulator may also comprise any other elements described herein (for example, any of the elements of circulator 308) or otherwise.

In some embodiments, the method 400 includes a step 408 of receiving, by the circulator, the return light signal from an environment, the return light signal comprising a first portion in a first polarization state and a second portion in a second polarization state. In some embodiments, the method 400 includes a step 410 of providing, by the circulator and on a third path, the first portion of the return light signal to a first element configured to reflect the first portion of the return light signal towards a photodetector. In some embodiments, the method 400 includes a step 412 of providing, by the circulator and on a fourth path, the second portion of the return light signal to a second element configured to reflect the second portion of the return light signal towards the first element, wherein the first element is further configured to transmit the first portion of the return light signal towards the photodetector. In some embodiments, the method 400 includes a step 414 of receiving, by the photodetector, the first portion of the return light signal and the second portion of the return light signal from the first element. In some embodiments, the first element is a polarizing beam cube configured to reflect the first portion of the return light signal towards the photodetector. In some embodiments, the second element is a reflector prism configured to reflect the second portion of the return light signal towards the first element, wherein the first element is further configured to transmit the second portion of the return light signal through the first element towards the photodetector. As one example scenario, the first polarization state associated with the first portion of the return light may be S polarized light and the second polarization state associated with the second portion of the return light may be P polarized light. In this same example scenario, the polarizing beam cube may be configured to reflect S polarized light, but may also be configured to transmit P polarized light (for example, allow P polarized light to pass through the polarizing beam splitter rather than reflecting from the polarizing beam splitter. Given this, if both the first portion of the return light and the second portion of the return light were provided to the polarizing beam splitter, then the first portion of the return light would be reflected towards the photodetector, whereas the second portion of the return light would transmit through the polarizing beam splitter and never be provided to the photodetector. Thus, the second portion of the return light may instead be provided to another element (for example, the reflector prism) that may be configured to reflect the P polarized light towards the polarizing beam splitter in a direction in line with the location of the photodetector (for example, the polarizing beam splitter may be located in a path between the reflector prism and the photodetector. The second portion of the return light may then be transmitted through the polarizing beam splitter towards the photodetector. In this manner, the photodetector may be able to receive some or all of the return light in different polarization states. It should be noted that this scenario may only be one non-limiting example, and the return light may also be in the form of any other number and or types of polarization states. Additionally, elements other than a polarizing beam splitter and/or a reflector prism may be used, as long as the elements that are used are able to direct some or all of the different polarization states of the return light in the direction of the photodetector.

In some embodiments, the method 400 further comprises receiving, by a QWP, the outbound light signal from a collimating lens. In some embodiments, the method 400 further comprises converting the outbound light signal from a linear polarization to a circular or elliptical polarization. The operations described and depicted in the illustrative process flow of FIG. 4 may be carried out or performed in any suitable order as desired in various example embodiments of the disclosure. Additionally, in certain example embodiments, at least a portion of the operations may be carried out in parallel. Furthermore, in certain example embodiments, less, more, or different operations than those depicted in FIG. 4 may be performed.

FIG. 5 illustrates an example computing system 500, in accordance with one or more embodiments of this disclosure. The computing 500 device may be representative of any number of elements described herein, such as the computing system 106, or any other element described herein. The computing system 500 may include at least one processor 502 that executes instructions that are stored in one or more memory devices (referred to as memory 504). The instructions can be, for instance, instructions for implementing functionality described as being carried out by one or more modules and systems disclosed above or instructions for implementing one or more of the methods disclosed above. The processor(s) 502 can be embodied in, for example, a CPU, multiple CPUs, a GPU, multiple GPUs, a TPU, multiple TPUs, a multi-core processor, a combination thereof, and the like. In some embodiments, the processor(s) 502 can be arranged in a single processing device. In other embodiments, the processor(s) 502 can be distributed across two or more processing devices (for example, multiple CPUs; multiple GPUs; a combination thereof, or the like). A processor can be implemented as a combination of processing circuitry or computing processing units (such as CPUs, GPUs, or a combination of both). Therefore, for the sake of illustration, a processor can refer to a single-core processor; a single processor with software multithread execution capability; a multi-core processor; a multi-core processor with software multithread execution capability; a multi-core processor with hardware multithread technology; a parallel processing (or computing) platform; and parallel computing platforms with distributed shared memory. Additionally, or as another example, a processor can refer to an integrated circuit (IC), an ASIC, a digital signal processor (DSP), an FPGA, a PLC, a complex programmable logic device (CPLD), a discrete gate or transistor logic, discrete hardware components, or any combination thereof designed or otherwise configured (for example, manufactured) to perform the functions described herein.

The processor(s) 502 can access the memory 504 by means of a communication architecture 506 (for example, a system bus). The communication architecture 506 may be suitable for the particular arrangement (localized or distributed) and type of the processor(s) 502. In some embodiments, the communication architecture 506 can include one or many bus architectures, such as a memory bus or a memory controller; a peripheral bus; an accelerated graphics port; a processor or local bus; a combination thereof, or the like. As an illustration, such architectures can include an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, a Peripheral Component Interconnect (PCI) bus, a PCI-Express bus, a Personal Computer Memory Card International Association (PCMCIA) bus, a Universal Serial Bus (USB), and/or the like.

Memory components or memory devices disclosed herein can be embodied in either volatile memory or non-volatile memory or can include both volatile and non-volatile memory. In addition, the memory components or memory devices can be removable or non-removable, and/or internal or external to a computing device or component. Examples of various types of non-transitory storage media can include hard-disc drives, zip drives, CD-ROMs, digital versatile disks (DVDs) or other optical storage, magnetic cassettes, magnetic tape, magnetic disk storage or other magnetic storage devices, flash memory cards or other types of memory cards, cartridges, or any other non-transitory media suitable to retain the desired information and which can be accessed by a computing device.

As an illustration, non-volatile memory can include read-only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The disclosed memory devices or memories of the operational or computational environments described herein are intended to include one or more of these and/or any other suitable types of memory. In addition to storing executable instructions, the memory 504 also can retain data.

Each computing system 500 also can include mass storage 508 that is accessible by the processor(s) 502 by means of the communication architecture 506. The mass storage 508 can include machine-accessible instructions (for example, computer-readable instructions and/or computer-executable instructions). In some embodiments, the machine-accessible instructions may be encoded in the mass storage 508 and can be arranged in components that can be built (for example, linked and compiled) and retained in computer-executable form in the mass storage 508 or in one or more other machine-accessible non-transitory storage media included in the computing system 500. Such components can embody, or can constitute, one or many of the various modules disclosed herein. Such modules are illustrated as modules 514. In some instances, the modules may also be included within the memory 504 as well.

Execution of the modules 514, individually or in combination, by at least one of the processor(s) 502, can cause the computing system 500 to perform any of the operations described herein (for example, the operations described with respect to FIG. 4, as well as any other operations).

Each computing system 500 also can include one or more input/output interface devices 510 (referred to as I/O interface 510) that can permit or otherwise facilitate external devices to communicate with the computing system 500. For instance, the I/O interface 510 may be used to receive and send data and/or instructions from and to an external computing device.

The computing system 500 also includes one or more network interface devices 512 (referred to as network interface(s) 512) that can permit or otherwise facilitate functionally coupling the computing system 500 with one or more external devices. Functionally coupling the computing system 500 to an external device can include establishing a wireline connection or a wireless connection between the computing system 500 and the external device. The network interface devices 512 can include one or many antennas and a communication processing device that can permit wireless communication between the computing system 500 and another external device. For example, between a vehicle and a smart infrastructure system, between two smart infrastructure systems, etc. Such a communication processing device can process data according to defined protocols of one or several radio technologies. The radio technologies can include, for example, 3G, Long Term Evolution (LTE), LTE-Advanced, 5G, IEEE 802.11, IEEE 802.16, Bluetooth, ZigBee, near-field communication (NFC), and the like. The communication processing device can also process data according to other protocols as well, such as vehicle-to-infrastructure (V2I) communications, vehicle-to-vehicle (V2V) communications, and the like. The network interface(s) 512 may also be used to facilitate peer-to-peer ad-hoc network connections as described herein.

It should further be appreciated that the LIDAR system 100 (or any other LIDAR system described herein) may include alternate and/or additional hardware, software, or firmware components beyond those described or depicted without departing from the scope of the disclosure. More particularly, it should be appreciated that software, firmware, or hardware components depicted as forming part of the computing device 600 are merely illustrative and that some components may not be present or additional components may be provided in various embodiments. While various illustrative program modules have been depicted and described as software modules stored in data storage, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure.

Certain aspects of the disclosure are described above with reference to block and flow diagrams of systems, methods, apparatuses, and/or computer program products according to example embodiments. It will be understood that one or more blocks of the block diagrams and flow diagrams, and combinations of blocks in the block diagrams and the flow diagrams, respectively, may be implemented by execution of computer-executable program instructions. Likewise, some blocks of the block diagrams and flow diagrams may not necessarily need to be performed in the order presented, or may not necessarily need to be performed at all, according to some embodiments. Further, additional components and/or operations beyond those depicted in blocks of the block and/or flow diagrams may be present in certain embodiments.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

What has been described herein in the present specification and annexed drawings includes examples of systems, devices, techniques, and computer program products that, individually and in combination, permit the automated provision of an update for a vehicle profile package. It is, of course, not possible to describe every conceivable combination of components and/or methods for purposes of describing the various elements of the disclosure, but it can be recognized that many further combinations and permutations of the disclosed elements are possible. Accordingly, it may be apparent that various modifications can be made to the disclosure without departing from the scope or spirit thereof. In addition, or as an alternative, other embodiments of the disclosure may be apparent from consideration of the specification and annexed drawings, and practice of the disclosure as presented herein. It is intended that the examples put forth in the specification and annexed drawings be considered, in all respects, as illustrative and not limiting. Although specific terms are employed herein, they are used in a generic and descriptive sense only and not for purposes of limitation.

As used in this application, the terms “environment,” “system,” “unit,” “module,” “architecture,” “interface,” “component,” and the like refer to a computer-related entity or an entity related to an operational apparatus with one or more defined functionalities. The terms “environment,” “system,” “module,” “component,” “architecture,” “interface,” and “unit,” can be utilized interchangeably and can be generically referred to functional elements. Such entities may be either hardware, a combination of hardware and software, software, or software in execution. As an example, a module can be embodied in a process running on a processor, a processor, an object, an executable portion of software, a thread of execution, a program, and/or a computing device. As another example, both a software application executing on a computing device and the computing device can embody a module. As yet another example, one or more modules may reside within a process and/or thread of execution. A module may be localized on one computing device or distributed between two or more computing devices. As is disclosed herein, a module can execute from various computer-readable non-transitory storage media having various data structures stored thereon. Modules can communicate via local and/or remote processes in accordance, for example, with a signal (either analogic or digital) having one or more data packets (for example data from one component interacting with another component in a local system, distributed system, and/or across a network such as a wide area network with other systems via the signal).

As yet another example, a module can be embodied in or can include an apparatus with a defined functionality provided by mechanical parts operated by electric or electronic circuitry that is controlled by a software application or firmware application executed by a processor. Such a processor can be internal or external to the apparatus and can execute at least part of the software or firmware application. Still in another example, a module can be embodied in or can include an apparatus that provides defined functionality through electronic components without mechanical parts. The electronic components can include a processor to execute software or firmware that permits or otherwise facilitates, at least in part, the functionality of the electronic components.

In some embodiments, modules can communicate via local and/or remote processes in accordance, for example, with a signal (either analog or digital) having one or more data packets (for example data from one component interacting with another component in a local system, distributed system, and/or across a network such as a wide area network with other systems via the signal). In addition, or in other embodiments, modules can communicate or otherwise be coupled via thermal, mechanical, electrical, and/or electromechanical coupling mechanisms (such as conduits, connectors, combinations thereof, or the like). An interface can include input/output (I/O) components as well as associated processors, applications, and/or other programming components.

Further, in the present specification and annexed drawings, terms such as “store,” “storage,” “data store,” “data storage,” “memory,” “repository,” and substantially any other information storage component relevant to the operation and functionality of a component of the disclosure, refer to memory components, entities embodied in one or several memory devices, or components forming a memory device. It is noted that the memory components or memory devices described herein embody or include non-transitory computer storage media that can be readable or otherwise accessible by a computing device. Such media can be implemented in any methods or technology for storage of information, such as machine-accessible instructions (for example computer-readable instructions), information structures, program modules, or other information objects.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

In some embodiments, additional embodiments for achieving the improvements described herein may be performed using any of the alternative options described in Exhibit A below.

That which is claimed is:

1. A LIDAR system comprising:
an emitter configured to emit an outbound light signal;
a photodetector configured to receive a return light signal that is based on the outbound light signal; and
a circulator disposed in a first path of the outbound light signal and second path of the return light signal, the circulator configured to:
receive the outbound light signal from the emitter;
output the outbound light signal;
receive the return light signal from an environment, the return light signal comprising a first portion in a first polarization state and a second portion in a second polarization state;
provide, on a third path, the first portion of the return light signal to a first element configured to reflect the first portion of the return light signal towards the photodetector;
provide, on a fourth path, the second portion of the return light signal to a second element configured to reflect the second portion of the return light signal towards the first element, wherein the first element is further configured to transmit the first portion of the return light signal towards the photodetector; and
receive, by the photodetector, the first portion of the return light signal and the second portion of the return light signal from the first element.

2. The LIDAR system of claim 1, wherein the circulator further comprises a first birefringent beam displacer, wherein provide the first portion of the return light signal to the first element and provide the second portion of the return light signal to the second element are performed by the first birefringent beam displacer, and wherein the first birefringent beam displacer is further configured to separate the outbound light signal into a first portion of the outbound light signal in a third polarization state and a second portion of the outbound light signal in a fourth polarization state.

3. The LIDAR system of claim 1, wherein the circulator further comprises a second birefringent beam displacer configured to separate the first portion of the return light signal onto the first path and the second portion of the return light signal onto the second path.

4. The LIDAR system of claim 3, wherein the second birefringent beam displacer is further configured to combine a first portion of the outbound light signal in a third polarization state and a second portion of the outbound light signal in a fourth polarization state.

5. The LIDAR system of claim 1, further comprising:
a collimating lens configured to receive the outbound light signal from the emitter, collimate the outbound light signal, and provide the outbound light signal to a quarter wave plate (QWP); and
the QWP configured to receive the outbound light signal from the collimating lens and also configured to convert the outbound light signal from a linear polarization to a circular or elliptical polarization.

6. The LIDAR system of claim 1, wherein the first element is a polarizing beam cube, and wherein the second element is a reflector prism.

7. The LIDAR system of claim 1, wherein one or more paths of the outbound light signal are spatially separated from the third path and the fourth path.

8. A method comprising:
emitting, by an emitter, an outbound light signal;
receiving, by a circulator disposed a first path of the outbound light signal and a second path of a return light signal, the outbound light signal from the emitter;
outputting the outbound light signal;
receiving, by the circulator, the return light signal from an environment, the return light signal comprising a first portion in a first polarization state and a second portion in a second polarization state;
providing, by the circulator and on a third path, the first portion of the return light signal to a first element configured to reflect the first portion of the return light signal towards a photodetector;
providing, by the circulator and on a fourth path, the second portion of the return light signal to a second element configured to reflect the second portion of the return light signal towards the first element, wherein the first element is further configured to transmit the first portion of the return light signal towards the photodetector; and
receiving, by the photodetector, the first portion of the return light signal and the second portion of the return light signal from the first element.

9. The method of claim 8, wherein the circulator further comprises a first birefringent beam displacer, wherein providing the first portion of the return light signal to the first element and providing the second portion of the return light signal to the second element are performed by the first birefringent beam displacer, and wherein the method further comprises separating, by the first birefringent beam displacer, the outbound light signal into a first portion of the outbound light signal in a third polarization state and a second portion of the outbound light signal in a fourth polarization state.

10. The method of claim 8, wherein the circulator further comprises a second birefringent beam displacer, and wherein the method further comprises separating, by the second birefringent beam displacer, the first portion of the return light signal onto the first path and the second portion of the return light signal onto the second path.

11. The method of claim 10, further comprising:
combining, by the second birefringent beam displacer, a first portion of the outbound light signal in a third polarization state and a second portion of the outbound light signal in a fourth polarization state.

12. The method of claim 11, further comprising:
receiving, by a QWP, the outbound light signal from a collimating lens; and
converting the outbound light signal from a linear polarization to a circular or elliptical polarization.

13. The method of claim 8, wherein the first element is a polarizing beam cube, and wherein the second element is a reflector prism.

14. The method of claim 8, wherein one or more paths of the outbound light signal are spatially separated from the third path and the fourth path.

15. An optical system comprising:
an emitter configured to emit an outbound light signal;
a photodetector configured to receive a return light signal that is based on the outbound light signal; and
a circulator disposed in a first path of the outbound light signal and second path of the return light signal, the circulator configured to:
receive the outbound light signal from the emitter;
output the outbound light signal;
receive the return light signal from an environment, the return light signal comprising a first portion in a first polarization state and a second portion in a second polarization state;
provide, on a third path, the first portion of the return light signal to a first element configured to reflect the first portion of the return light signal towards the photodetector;
provide, on a fourth path, the second portion of the return light signal to a second element configured to reflect the second portion of the return light signal towards the first element, wherein the first element is further configured to transmit the first portion of the return light signal towards the photodetector; and
receive, by the photodetector, the first portion of the return light signal and the second portion of the return light signal from the first element.

16. The optical system of claim 15, wherein the circulator further comprises a first birefringent beam displacer, wherein provide the first portion of the return light signal to the first element and provide the second portion of the return light signal to the second element are performed by the first birefringent beam displacer, and wherein the first birefringent beam displacer is further configured to separate the outbound light signal into a first portion of the outbound light signal in a third polarization state and a second portion of the outbound light signal in a fourth polarization state.

17. The optical system of claim 15, wherein the circulator further comprises a second birefringent beam displacer configured to separate the first portion of the return light signal onto the first path and the second portion of the return light signal onto the second path.

18. The optical system of claim 17, wherein the second birefringent beam displacer is further configured to combine a first portion of the outbound light signal in a third polarization state and a second portion of the outbound light signal in a fourth polarization state.

19. The optical system of claim 15, further comprising:
a collimating lens configured to receive the outbound light signal from the emitter, collimate the outbound light signal, and provide the outbound light signal to a quarter wave plate (QWP); and
the QWP configured to receive the outbound light signal from the collimating lens and also configured to convert the outbound light signal from a linear polarization to a circular or elliptical polarization.

20. The optical system of claim 15, wherein one or more paths of the outbound light signal are spatially separated from the third path and the fourth path.
